(19) United States
(12) Patent Application Publication
(10) Pub. No.: US 2003/0164072 A1
(43) Pub. Date: Sep. 4, 2003

(54) Wrench locking and positioning device

(76) Inventor: Chorng-Jiang Lin, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/086,437

(22) Filed: Mar. 4, 2002

(51) Int. Cl. B25B 13/58

(52) U.S. Cl. 81/180.1

(57) ABSTRACT

A wrench locking and positioning device includes at least one positioning body formed with an oblique slide guide portion facing an end face of a drive portion of a drive head of a wrench, and an elastic member mounted in the positioning body, for normally pushing the oblique slide guide portion of the positioning body to extend into the drive portion of the drive head of the wrench.

### BACKGROUND OF THE INVENTION

1. Field of the Invention

The present invention relates to a wrench locking and positioning device, and more particularly to a wrench locking and positioning device including a positioning body that may provide a retaining and positioning effect on the workpiece, thereby facilitating the drive portion of the drive head of the wrench rotating the workpiece.

2. Description of the Related Art

A first conventional wrench in accordance with the prior comprises a drive head having a drive portion for rotating a workpiece such as a bolt, a nut or the like. The drive portion of the drive head of the wrench is formed an opening for receiving the workpiece, and the opening is usually defined through the drive portion of the drive head of the wrench. Thus, the workpiece is easily detached from the opening of the drive portion of the drive head of the wrench, thereby causing inconvenience to the user.

A second conventional wrench in accordance with the prior comprises a C-shaped snap mounted in the drive portion of the drive head of the wrench for retaining the workpiece. However, the C-shaped snap largely decreases the structural strength of the drive portion of the drive head of the wrench, so that the drive portion of the drive head of the wrench is easily broken due to the larger force.

### SUMMARY OF THE INVENTION

The present invention has arisen to mitigate and/or obviate the disadvantage of the conventional wrench.

The primary objective of the present invention is to provide a wrench locking and positioning device including a positioning body that may provide a retaining and positioning effect on the workpiece, thereby facilitating the drive portion of the drive head of the wrench rotating the workpiece.

Another objective of the present invention is to provide a wrench locking and positioning device, wherein the drive head of the wrench may operate the workpiece rigidly and stably by the positioning body, thereby facilitating the drive head of the wrench rotating the workpiece.

A further objective of the present invention is to provide a wrench locking and positioning device, wherein the locking body of the drive head of the wrench may be locked in the locking groove of the positioning body during movement of the positioning body, thereby providing a temporary positioning effect on the positioning body.

A further objective of the present invention is to provide a wrench locking and positioning device, wherein the oblique slide guide portion of the positioning body has a flat portion that may be rested on the workpiece rigidly and exactly, thereby facilitating the drive head of the wrench rotating the workpiece.

In accordance with the present invention, there is provided a wrench locking and positioning device, comprising:

at least one positioning body formed with an oblique slide guide portion facing an end face of a drive portion of a drive head of a wrench; and

an elastic member mounted in the positioning body, for normally pushing the oblique slide guide portion of the positioning body to extend into the drive portion of the drive head of the wrench.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a wrench locking and positioning device in accordance with a first embodiment of the present invention;

FIG. 2 is a side plan cross-sectional assembly view of the wrench locking and positioning device as shown in FIG. 1;

FIG. 3 is an exploded perspective view of a wrench locking and positioning device in accordance with a second embodiment of the present invention;

FIG. 3a is a side plan cross-sectional assembly view of the wrench locking and positioning device as shown in FIG. 3;

FIG. 4 is a plan assembly view of the wrench locking and positioning device as shown in FIG. 3;

FIG. 5 is a plan assembly view of the wrench locking and positioning device which may be used to a closed-ended wrench;

FIG. 6a is an operational view of the wrench locking and positioning device as shown in FIG. 5;

FIG. 6b is an operational view of the wrench locking and positioning device as shown in FIG. 6a;

FIG. 6c is an operational view of the wrench locking and positioning device as shown in FIG. 6b;

FIG. 7 is a plan assembly view of a wrench locking and positioning device in accordance with a third embodiment of the present invention;

FIG. 8 is a plan assembly view of a wrench locking and positioning device in accordance with a fourth embodiment of the present invention;

FIG. 9 is a plan assembly view of a wrench locking and positioning device which may be used to a fixed wrench;

FIG. 10 is an exploded perspective view of a wrench locking and positioning device in accordance with a fifth embodiment of the present invention;

FIG. 11 is a side plan cross-sectional assembly view of a wrench locking and positioning device in accordance with a sixth embodiment of the present invention;

FIG. 12 is a front plan cross-sectional assembly view of a wrench locking and positioning device in accordance with a sixth embodiment of the present invention; and

FIG. 13 is an exploded perspective view of a wrench locking and positioning device in accordance with a seventh embodiment of the present invention.

### DETAILED DESCRIPTION OF THE INVENTION

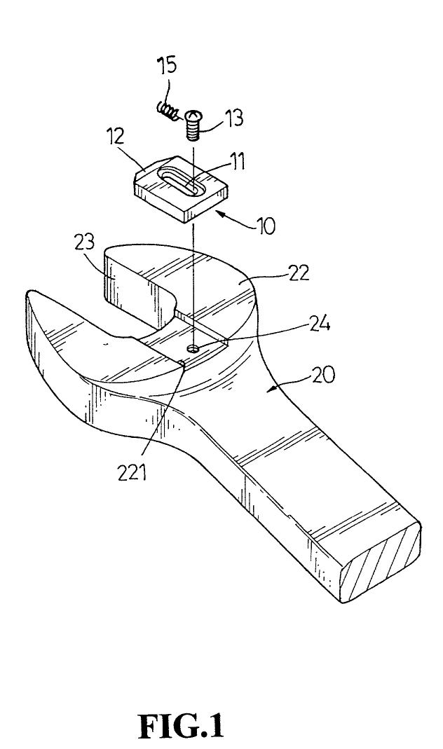

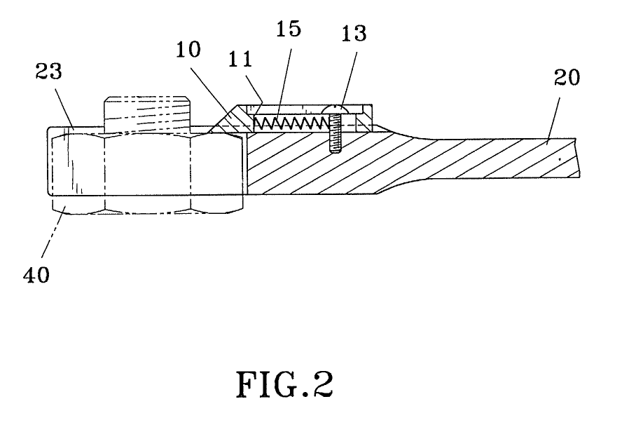

Referring to the drawings and initially to FIGS. 1 and 2, a wrench locking and positioning device in accordance with a first embodiment of the present invention comprises a plate-shaped positioning body 10 formed with an elongated retaining slot 11. The positioning body 10 has an end portion provided with an oblique slide guide portion 12.

A retaining member 13, such as a screw, is extended through the retaining slot 11 of the positioning body 10, and is screwed into an end face of the wrench 20.

An elastic member 15 is mounted in the retaining slot 11 of the positioning body 10, and is biased between the retaining member 13 and a wall of the retaining slot 11 of the positioning body 10, thereby providing an elastic restoring force to the positioning body 10. Preferably, the elastic member 15 is a compression spring.

The wrench 20 has a drive head 22 provided with an opened drive portion 23. The drive head 22 of the wrench 20 is formed with a locking bore 24 into which the retaining member 13 is screwed, so that the retaining member 13 may be used to limit the sliding stroke of the positioning body 10.

Thus, the positioning body 10 is pushed by the elastic member 15 toward the drive portion 23 of the drive head 22 of the wrench 20, so that the oblique slide guide portion 12 of the positioning body 10 may be moved to extend into the space of the drive portion 23 of the drive head 22 of the wrench 20 as shown in FIG. 2, and may be rested on a workpiece, such as a bolt, a nut or the like, received in the space of the drive portion 23 of the drive head 22 of the wrench 20, so as to provide a retaining and positioning effect on the workpiece, thereby facilitating the drive portion 23 of the drive head 22 of the wrench 20 rotating the workpiece.

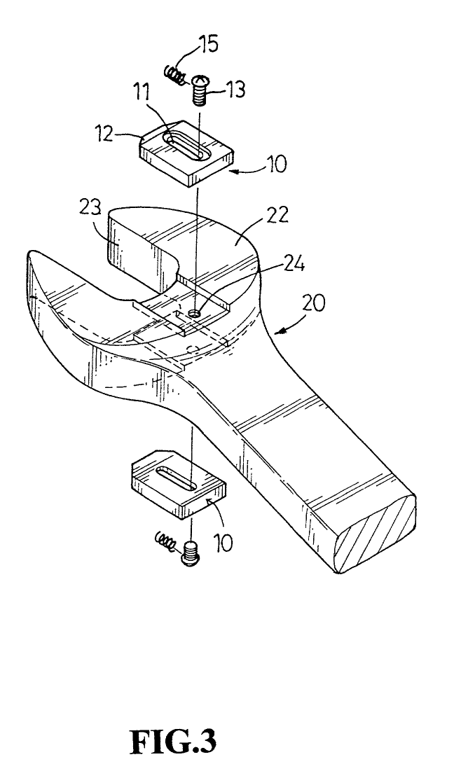

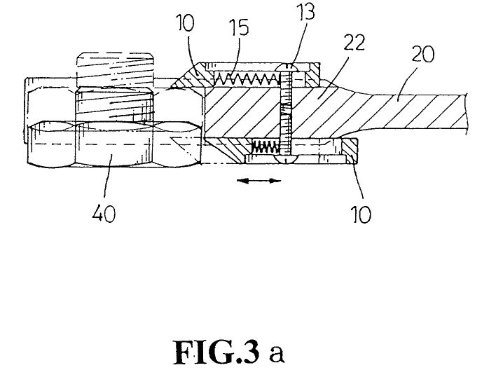

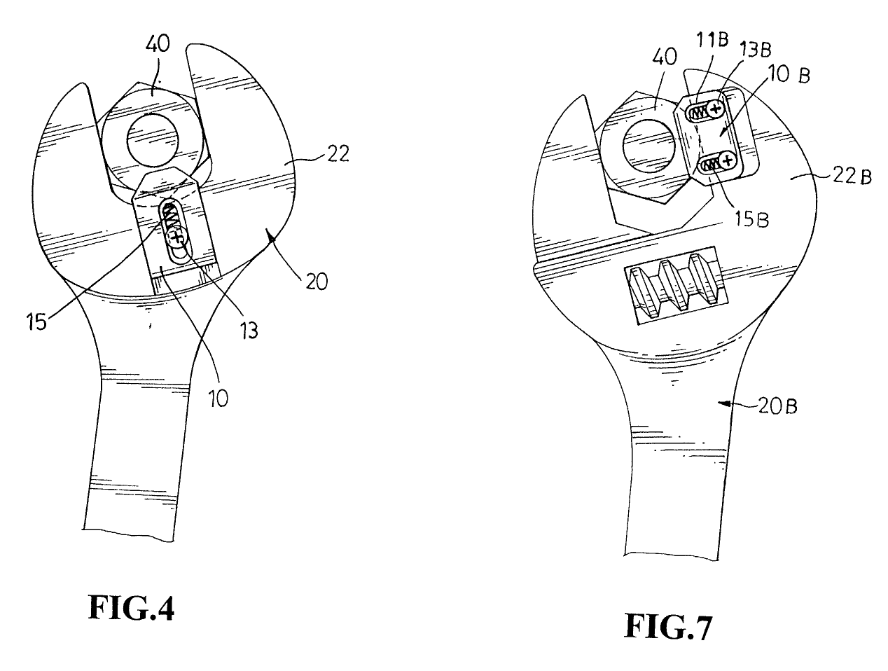

Referring to FIGS. 3 and 4, a wrench locking and positioning device in accordance with a second embodiment of the present invention comprises two positioning bodies 10 respectively mounted on the top side and the bottom side of the drive head 22 of the wrench 20.

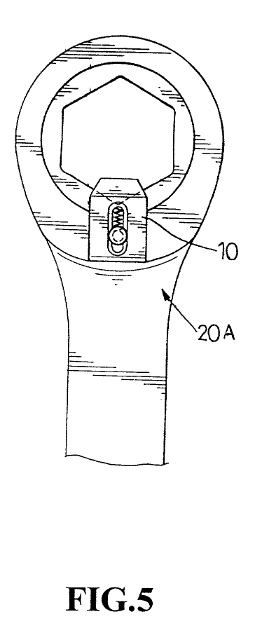

Referring to FIG. 5, the positioning body 10 of the wrench locking and positioning device in accordance with the present invention may be used to a closed-ended wrench 20A.

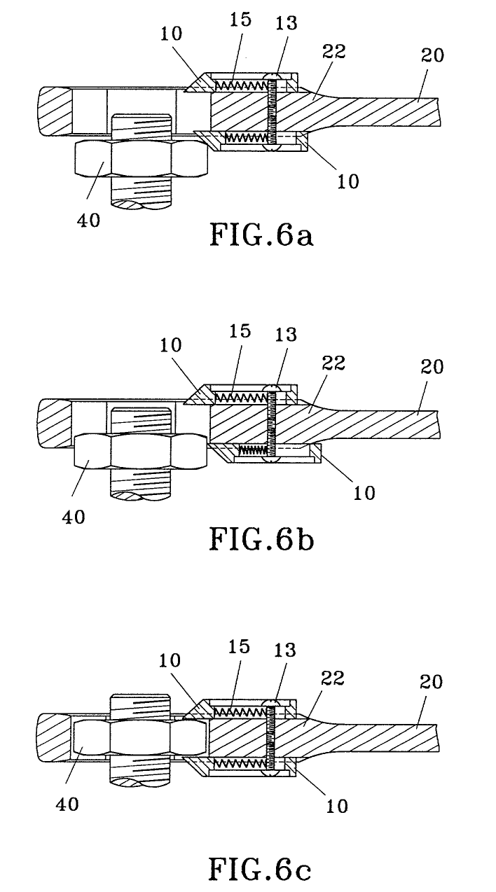

As shown in FIGS. 3a, 6a, 6b and 6c, the oblique slide guide portion 12 of the lower positioning body 10 may be pressed by the workpiece 40 to move toward the drive head 22 of the wrench 20, so as to retract the lower positioning body 10. Then, the workpiece 40 may be received in the space of the drive portion 23 of the drive head 22 of the wrench 20, and may be retained and positioned by the upper positioning body 10 and the lower positioning body 10, so that the drive portion 23 of the drive head 22 of the wrench 20 may operate the workpiece 40 rigidly and stably, thereby facilitating the drive portion 23 of the drive head 22 of the wrench 20 rotating the workpiece 40.

Referring to FIG. 7, a wrench locking and positioning device in accordance with a third embodiment of the present invention is used to the drive head 22B of a movable wrench 20B, and comprises a positioning body 10B formed with two elongated retaining slots 11B for receiving two retaining members 13B and two elastic members 15B.

Thus, the drive head 22B of the wrench 20B may operate the workpiece 40 rigidly and stably, thereby facilitating the drive head 22B of the wrench 20B rotating the workpiece 40.

Referring to FIGS. 1-7, the drive head 22 of the wrench 20 is formed with an elongated retaining groove 221, for limiting the sliding direction and position of the positioning body 10, thereby increasing the stability of movement of the positioning body 10.

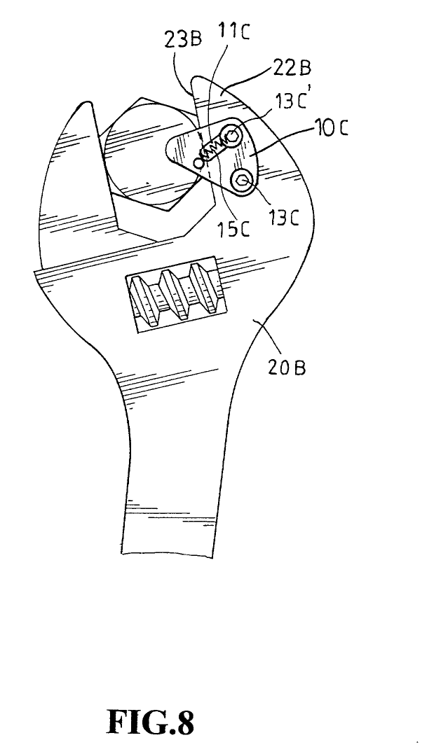

Referring to FIG. 8, a wrench locking and positioning device in accordance with a fourth embodiment of the present invention is used to the drive head 22B of a movable wrench 20B, and comprises a positioning body 10C formed with an arcuate retaining slot 11C. A first retaining member 13C is pivoted with the positioning body 10C, so that the positioning body 10C may be pivoted about the first retaining member 13C. A second retaining member 13C′ is received in the arcuate retaining slot 11C of the positioning body 10C, so that the second retaining member 13C′ may be used to limit the sliding stroke of the positioning body 10C.

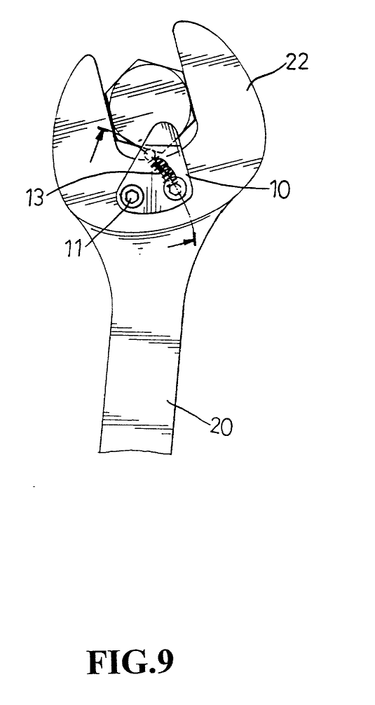

Referring to FIG. 9, the wrench locking and positioning device in accordance with a fourth embodiment of the present invention may be used to the drive head 22 of a fixed wrench 20.

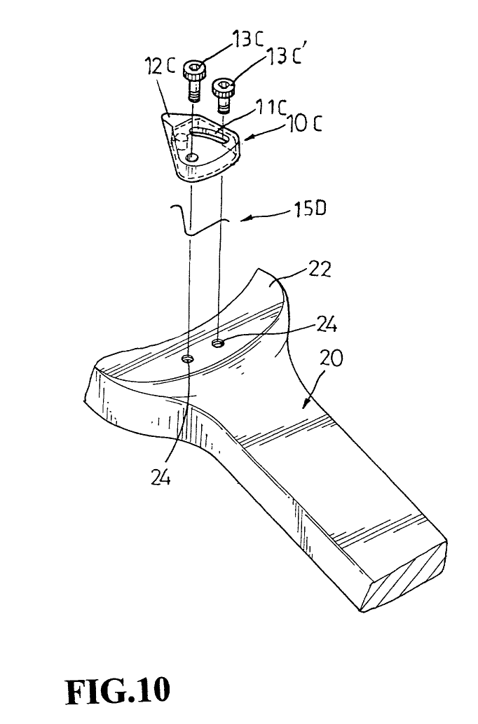

Referring to FIG. 10, a wrench locking and positioning device in accordance with a fifth embodiment of the present invention is used to the drive head 22 of a fixed wrench 20, wherein the elastic member 15D is a V-shaped elastic wire.

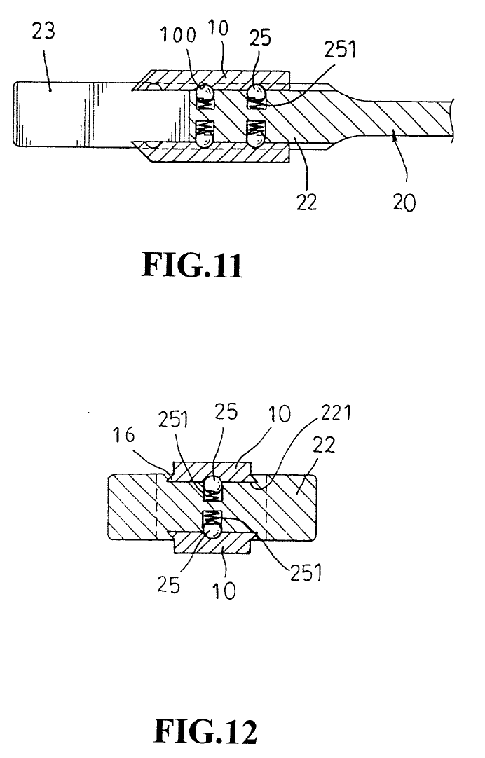

Referring to FIGS. 11 and 12, a wrench locking and positioning device in accordance with a sixth embodiment of the present invention is shown. The positioning body 10 is formed with at least one locking groove 100, and the drive head 22 of the wrench 20 is provided with at least one locking body 25, such as a ball, and at least one elastic member 251.

Thus, the locking body 25 may be locked in the locking groove 100 during movement of the positioning body 10, thereby providing a temporary positioning effect on the positioning body 10.

As shown in FIG. 12, the retaining groove 221 of the drive head 22 of the wrench 20 has a dovetail shape, and the positioning body 10 is provided with a dovetail-shaped portion 16 received in the dovetail-shaped retaining groove 221, thereby preventing the positioning body 10 from detaching from the drive head 22 of the wrench 20.

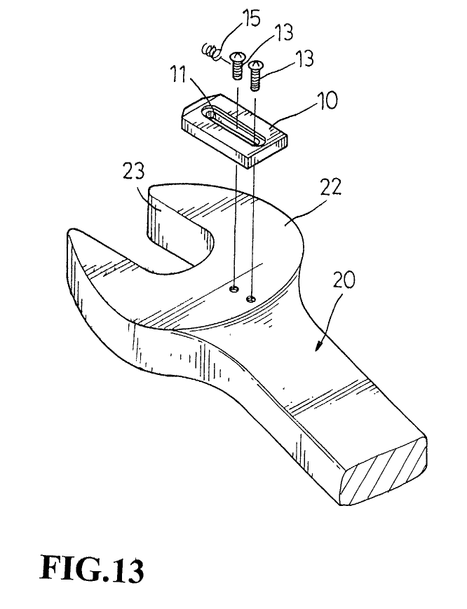

Referring to FIG. 13, a wrench locking and positioning device in accordance with a seventh embodiment of the present invention comprises two retaining members 13 respectively received in the retaining slot 11 of the positioning body 10.

Accordingly, the wrench locking and positioning device in accordance with the present invention has the following advantages.

1. The positioning body may provide a retaining and positioning effect on the workpiece, thereby facilitating the drive portion of the drive head of the wrench rotating the workpiece.

2. The drive head of the wrench may operate the workpiece rigidly and stably by the positioning body, thereby facilitating the drive head of the wrench rotating the workpiece.

3. The locking body of the drive head of the wrench may be locked in the locking groove of the positioning body during movement of the positioning body, thereby providing a temporary positioning effect on the positioning body.

4. The oblique slide guide portion of the positioning body has a flat portion that may be rested on the workpiece rigidly and exactly, thereby facilitating the drive head of the wrench rotating the workpiece.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wrench locking and positioning device, comprising:
at least one positioning body formed with an oblique slide guide portion facing an end face of a drive portion of a drive head of a wrench; and
an elastic member mounted in the positioning body, for normally pushing the oblique slide guide portion of the positioning body to extend into the drive portion of the drive head of the wrench.

2. The wrench locking and positioning device in accordance with claim 1, wherein the positioning body is formed with an elongated retaining slot, the oblique slide guide portion is formed on an end portion of the positioning body, a retaining member is extended through the retaining slot of the positioning body, and is screwed into an end face of the wrench, and the elastic member is mounted in the retaining slot of the positioning body, and is biased between the retaining member and a wall of the retaining slot of the positioning body, thereby providing an elastic restoring force to the positioning body.

3. The wrench locking and positioning device in accordance with claim 1, wherein the drive head of the wrench is formed with a locking bore into which the retaining member is screwed, so that the retaining member may be used to limit the sliding stroke of the positioning body.

4. The wrench locking and positioning device in accordance with claim 1, wherein the wrench locking and positioning device comprises two positioning bodies respectively mounted on the top side and the bottom side of the drive head of the wrench.

5. The wrench locking and positioning device in accordance with claim 1, wherein the positioning body is formed with two elongated retaining slots for receiving two retaining members and two elastic members.

6. The wrench locking and positioning device in accordance with claim 1, wherein the drive head of the wrench is formed with an elongated retaining groove, for limiting the sliding direction and position of the positioning body, thereby increasing the stability of movement of the positioning body.

7. The wrench locking and positioning device in accordance with claim 6, wherein the retaining groove of the drive head of the wrench has a dovetail shape, and the positioning body is provided with a dovetail-shaped portion received in the dovetail-shaped retaining groove, thereby preventing the positioning body from detaching from the drive head of the wrench.

8. The wrench locking and positioning device in accordance with claim 1, wherein the positioning body is formed with an arcuate retaining slot, a first retaining member is pivoted with the positioning body, so that the positioning body may be pivoted about the first retaining member, and a second retaining member is received in the arcuate retaining slot of the positioning body, so that the second retaining member may be used to limit the sliding stroke of the positioning body.

9. The wrench locking and positioning device in accordance with claim 1, wherein the elastic member is a compression spring.

10. The wrench locking and positioning device in accordance with claim 1, wherein the elastic member is a V-shaped elastic wire.

11. The wrench locking and positioning device in accordance with claim 1, wherein the positioning body is formed with at least one locking groove, and the drive head of the wrench is provided with at least one locking body and at least one elastic member, the locking body may be locked in the locking groove during movement of the positioning body, thereby providing a temporary positioning effect on the positioning body.

12. The wrench locking and positioning device in accordance with claim 11, wherein the locking body is a locking ball.

13. The wrench locking and positioning device in accordance with claim 1, wherein the wrench locking and positioning device comprises two retaining members respectively received in the retaining slot of the positioning body.
